(19) United States
(12) Patent Application Publication
(10) Pub. No.: US 2025/0151761 A1
(43) Pub. Date: May 15, 2025

(54) RED-COLORANT COMPOSITION FOR FAT-BASED FOODS AND OILS

(71) Applicant: CHR. HANSEN NATURAL COLORS A/S, Hoersholm (DK)

(72) Inventors: Dina DIX, Milwaukee, WI (US); Lori Napier, Milwaukee, WI (US); Adina Jerominski, Milwaukee, WI (US)

(73) Assignee: CHR. HANSEN NATURAL COLORS A/S, Hoersholm (DK)

(21) Appl. No.: 19/019,692

(22) Filed: Jan. 14, 2025

Related U.S. Application Data
(62) Division of application No. 17/612,671, filed on Nov. 19, 2021, now abandoned.

(30) Foreign Application Priority Data
May 31, 2019 (EP) 19177646.7

(51) Int. Cl. A23L 5/43; C09B 61/00; C09B 67/20

(52) U.S. Cl. CPC A23L 5/43; C09B 61/00; C09B 67/0069; A23V 2002/00

(57) ABSTRACT

Colorant particles are provided which comprise an anthocyanin-based colorant extract from red Sweet potato. The mean particle diameter (Dos) of said particles provides good suspension stability. An oil-based colorant composition comprising said particles is provided, as is a food product comprising the oil-based colorant composition.

### CROSS-REFERENCE TO RELATED APPLICATIONS

This application is a divisional application of U.S. application Ser. No. 17/612,671 filed Nov. 19, 2021, which is the United States entry of PCT Application No. PCT/EP2020/065059, filed May 29, 2020, claiming priority to European Patent Application No. 19177646.7 filed May 31, 2019.

### TECHNICAL FIELD

Colorant particles are provided, which comprise an anthocyanin-based colorant extract from red sweet potato, as is a food product comprising the colorant particles, and the use of the colorant particles for coloring. The mean particle diameter (D_{0.9}) of said colorant particles provides good suspension stability. An oil-based colorant composition comprising said colorant particles is provided, as is a food product comprising the oil-based colorant composition, and the use of the oil-based colorant composition for coloring. A method for producing the oil-based colorant composition and a method for producing a food product is also provided.

### BACKGROUND

Colorants containing natural coloring substances are commonly used in the manufacturing of e.g. food products and pharmaceutical products. However, there are increasingly strict requirements to be fulfilled for natural colorants to be accepted as a commercial coloring agent especially in the field of coloring food products, sweets and pharmaceuticals.

A colorant must be stable under common use conditions. This means that in many food applications a colorant must be thermally stable against heat exposure occurring on the occasion of e.g. food pasteurization prior to packaging or heating by the consumer prior to consumption. Also, the colorants must show sufficient photostability, i.e. they must be stable against light exposure over the lifetime of the colored (food) product without substantial color change or disappearance (fading).

Even further, the colorant must be stable against chemical interaction with other compounds in the environment of food. In addition, the colorant itself may not have a strong taste and/or odor in itself.

However, depending on the origin of the natural colorant, a colorant sometimes can have a strong taste and/or odor in itself, which would render it unsuitable as a colorant for certain (food) products. This is the case for colorant produced from red radish or red cabbage. For example, odor which originates from red radish can build up inside food packaging and release unpleasant odors when the packaging is opened.

Anthocyanins are well known as a group of compounds giving color to food, vegetables and flowers and are responsible for the blue, purple, violet, magenta, red and orange color of many plant species. Anthocyanins are water soluble, non-toxic pigments and therefore anthocyanins extracted from fruit and vegetables have been used as food colorants for providing colors in the orange to purple color range.

A vibrant, stable red colorant composition based on red sweet potato is described in WO2013/079518.

The sweet potato (Ipomoea batatas) is a member of the morning glory family, Convolvuacae. The sweet potato is unrelated to the regular potato (Solanum tuberosum).

Particular problems arise when anthocyanin-based colorant compositions are to be used in fat-based food products. As above, anthocyanins are typically water-soluble and fat-insoluble, in contrast to other natural colors. As such, it has proved difficult to provide stable red oil-based colorant compositions for red food products.

Additionally, many food products (e.g. snack-foods) include water-soluble color and flavor ingredients. If such water-soluble ingredients come into contact with water during production, they will readily dissolve, and thus “wash off” or otherwise disturb the production process. For this reason, contact with water is undesirable during the production of many food products.

Despite the known utility of natural food colorants including anthocyanin-based colorant compositions, there exists a desire to develop a greater diversity of color tones suitable for commercial colorants. A red color tone is especially desirable for coloring foods such as beverages, dairy food products, fruit preparations, snack-foods and confectionary and colorants.

The present technology aims to address at least some of the above problems.

### SUMMARY

It has been found by the present inventors that a stable oil-based colorant composition can be obtained using a suspension of colorant particles comprising anthocyanin-based colorant extract from red sweet potato, said colorant particles having a mean particle diameter (D_{0.9}) of less than 20 μm, such as 1-20 μm. A mean particle diameter (D_{0.9}) of less than 20 μm, such as 1-20 μm is important for a smooth texture, suspension of the pigments and color expression.

Provided herein are thus natural red-orange colorant particles especially suitable for food coloring of food products and especially fat-based food products. In a further aspect, the colorant particles provide a high brightness and have a clear and distinct color tone. In an aspect, the colorant particles are free of off-tastes or off-odors which would make them unsuitable for use in food coloring applications. Red-orange color tones can also be obtained using other colorants, such as carminic acid or red radish extracts. However, carminic acid is obtained from an animal source (bugs) and is thus not suitable for vegetarian consumers. Red radish is problematic as it contains sulfur compounds and thus has an undesirable characteristic smell and taste.

Colorant particles comprising anthocyanin-based colorant extract from red sweet potato, said colorant particles having a mean particle diameter (D_{0.9}) of less than 20 μm, and the use thereof for coloring, is provided. A food product, preferably a snack food, comprising the herein-disclosed colorant particles, is furthermore provided.

In a further aspect, an oil-based colorant composition, being a suspension of (a) said colorant particles, suspended in a mixture of (b) an edible oil and (c) an emulsifier, and the use of the oil-based colorant composition for coloring, is provided.

In yet a further aspect, a method for producing the oil-based colorant composition disclosed herein is provided, the method comprising the steps of:
a. blending an edible oil, an emulsifier and raw colorant particles comprising anthocyanin-based colorant extract from red sweet potato; said raw colorant particles having a mean particle diameter (D_{0.9}) greater than 20 μm;
b. milling the blend from step a. such that the colorant particles obtain a mean particle diameter (D_{0.9}) of less than 20 μm, thereby providing the oil-based colorant composition disclosed herein.

A food product, preferably a snack food, comprising the herein disclosed oil-based colorant composition, and a method for producing the food product, is provided.

### LEGENDS TO THE FIGURES

FIG. 1A shows an image of a blend according to Example 8 viewed under an optical microscope pre-milled.

FIG. 1B shows an image of a blend according to Example 8 viewed under an optical microscope after one milled pass.

### DETAILED DISCLOSURE OF THE INVENTION

Colorant particles comprising anthocyanin-based colorant extract from red sweet potato, said colorant particles having a mean particle diameter (D_{0.9}) of less than 20 μm are provided, which have a particular use in food products such as snack foods.

In an embodiment, the colorant particles have a mean particle diameter (D_{0.9}) of greater than 1 μm, such as greater than 2 μm, or greater than 4 μm. In a further embodiment disclosed herein, the colorant particles have a mean particle diameter (D_{0.9}) of less than 20 μm, less than 15 μm, preferably less than 12 μm. In yet a further embodiment, the colorant particles have a mean particle diameter (D_{0.9}) of 1-20 μm, such as 2-20 μm, 4-20 μm, 1-15 μm, 2-15 μm, or 4-15 μm. In yet a further embodiment, the colorant particles have a mean particle diameter (Dos) of 1-12 μm, such as 2-12 μm, or 4-12 μm.

In an embodiment disclosed herein, the colorant particles comprising anthocyanin-based colorant extract from red sweet potato may be prepared by a process including spray drying of a concentrated juice of red sweet potatoes. The red sweet potatoes may be water washed, and ground in the presence of acidified water and an enzyme such as pectinase or amylase, and the juice may then be extracted from the mash in the presence of a strong basic solution; e.g. sodium hydroxide. The juice may be concentrated through microfiltration or resin separation until the desired concentration is achieved. The concentrated juice may then be slurried with a carrier, such as maltodextrin, potato dextrose or glucose syrup solids, and spray dried to a specific strength and to a specific particle size.

The colorant particles, suitably further comprise a carrier material, which is preferably maltodextrin, potato dextrose or glucose syrup solids. The amount of anthocyanin-based colorant extract in the colorant particles is suitably between 15 and 30 weight %, preferably between 20 and 25 weight %. In a further embodiment, the colorant particles have a color strength in the range of 5-55 CU/kg, e.g. 9-12 CU/kg, 12-35 CU/kg, preferably 35-50 CU/kg such as 40-45 CU/kg. Wherein CU stands for Color Units.

The present anthocyanin-based colorant extract from red sweet potato is obtainable from extracts of different plant varieties, or can be obtained by extracting one single plant variety.

An example of a red sweet potato is the red variety of sweet potato Ipomoea batatas (referred to hereinafter as RSWP).

Thus, preferably the present colorant particles are obtainable from juices or extracts of RSWP, including both compositions consisting of or mainly comprising juices or extracts of RSWP.

In an embodiment, the RSWP extract comprises at least one pelargonidin-based anthocyanin. In an embodiment, the pelargonidin-based anthocyanins are present in the anthocyanin-based colorant extract as disclosed as the major anthocyanin component. More precisely, the amount of pelargonidin-based anthocyanins, based on all anthocyanins present in the extract is 50-90 mol-%. Preferably, the amount of pelargonidin-based anthocyanins is 55-85 mol-%, more preferred 60-80 mol-%.

An oil-based colorant composition, being a suspension of (a) colorant particles as disclosed herein, suspended in a mixture of (b) an edible oil and (c) an emulsifier, is provided.

In an embodiment the colorant composition comprises the herein disclosed colorant particles in an amount of 0.1-40 weight %, more preferred in an amount of 0.1-30 weight %, or in amount of 0.1-55 weight %, such as between 10-50 weight %, such as between 20-50 weight %, such as between 30-50 weight %. In an embodiment, the colorant composition comprises the emulsifier in an amount of 0.1-5 weight %, such as in an amount of 0.1-3 weight %, such as in an amount of 0.5-5 weight %, such as in an amount of 1-4 weight %, such as in an amount of 1.5-3 weight %.

Emulsifiers may be used to increase viscosity of the oil phase and to provide friction in the milling process. Specific emulsifiers include, but are not limited to, mono and di-glycerides, distilled monoglycerides and esters of mono and di-glycerides.

In an embodiment, the emulsifier is a non-ionic emulsifier, preferably a fatty acid ester or fatty acid amide of a polyalcohol, more preferably a fatty acid ester of a polyalcohol.

In a further embodiment, the fatty acid ester or fatty acid amide comprises a C2-C22 fatty acid moiety, e.g. a C4-C18 fatty acid moiety or a C6-C12 fatty acid moiety. In a further embodiment, the fatty acid moiety is saturated.

In a further embodiment, the polyalcohol is selected from glycerol, sorbitan, ethoxylated sorbitan, glucose, ethylene glycol, polyethylene glycol or amine derivatives thereof, preferably glycerol.

In a further embodiment, the emulsifier is a mono- or a di-fatty acid ester of glycerol, optionally comprising an additional C1-C6 ester moiety, such as a citric acid ester moiety.

In an embodiment, the colorant composition disclosed herein comprises the edible oil in an amount of less than 60 weight %, preferably an amount of 50-60 weight %, more preferably 57-59 weight %.

In an embodiment, the edible oil is selected from the group consisting of sunflower oil, soya oil, coconut oil, canola oil, olive oil, palm oil, corn oil and mixtures thereof, preferably sunflower oil and soya oil or mixtures thereof.

In an embodiment, the colorant composition disclosed herein has a red color with a hue value H in the L*C*h color system in the range of 5-30, preferably 8-20, and an L*-value of 60.0-71.0. The hue value (H) is measured in a 0.1 mol/l trisodium citrate dihydrate buffer at pH 3 in a 1 cm-length quartz cell using Spectraflash 650 (Datacolor) in transmission mode under D65 illuminant 10 Deg).

Anthocyanins are known to shift from red in acidic systems to purple in neutral systems. The degree of shift towards blue is dependent on the specific anthocyanin. Some juices for coloring purposes are known to shift bluer than others due to the type of anthocyanins present. The utilization of red sweet potato for a bright red oil-soluble shade is the preferred anthocyanin source due to less shifting of the red color. Additionally, if a blend is made of the oil soluble red to create orange, purple or brown, the anthocyanin will create a color that will shift with changes in pH, leading to undesirable color changes in the application.

In the intended applications, red shade maintenance is preferred for:
Red color maintenance in fat fillings and icings. The area of interface of a baked good with a fat-based filling, icing or frosting may shift in color, causing a defect that may prompt consumer complaints. Additionally, in color blends, the intended shade will shift to an undesirable shade at the interface with the baked good.
Red color maintenance in compound coatings for use in baking chips, ice cream coatings and other confectionery coatings.
Maintenance of red color with less shifting towards blue is particularly important for baking chips or chunks. As the colored compound coating is baked, anthocyanins, being water soluble, will bleed into the surrounding batter or dough, creating a bluish ring around the chip. The blue ring is greatly reduced when the chip is colored red or a red derivative such as purple, orange or brown, with the red color coming from red sweet potato.

In an embodiment, the colorant composition disclosed herein further comprises an additional food colorant, preferably which is obtainable from an extract or a juice of aronia, bilberry, black carrot, blackcurrant, blueberry, cherry, elderberry, hibiscus, lingonberry, purple corn, red grape, purple sweet potato or another red sweet potato variant.

In an embodiment, the colorant composition disclosed herein further comprises at least one water-soluble food ingredient(s), such as salt or sugar.

The present technology is particularly useful in spicy snacks, so as to give the impression of spice. In snack seasonings, the oil dispersible color can be dispersed onto a dry seasoning to yield a bright red seasoning indicative of spicy snacks. The colored seasoning can then be applied to snack foods according to known and commonly practiced application methods. Examples of suitable snack-foods include e.g. chips, including potato chips, maize chips; or starch snacks such as expanded corn, rice, potato snacks; nuts, and cookies. The colored seasoning can be applied by dry waterfall, in an oil slurry application or tumbling with the snack food. A snack seasoning is thus provided which comprises the colorant composition described herein, plus one or more flavorings e.g. salt.

Alternatively, in an oil slurry application, the color can be added directly to the oil prior to adding uncolored seasoning. The oil slurry can be applied as usual to the snack food.

In fat based crème fillings, the color can be added up to 10% under standard manufacturing conditions. The fat based filling can contain 0-10% water.

Fat based confections including but not limited to, colored baking chips based on cocoa butter and/or other fats, compound coatings, confectionery bark, chocolate based foods and coatings. A fat-based food is a food that comprises 90-100 weight % of an oil or fat phase and 0-10% of a water phase.

In an embodiment, a food product comprising the oil-based colorant composition as disclosed herein is provided. In a further embodiment, the food product comprises at least one water-soluble food ingredient. Suitably, the food product disclosed herein is selected from the group consisting of dairy food products, baked goods, fruit preparations, snack-foods, seasoning mix and confectionery, preferably snack foods, seasoning mix or baked goods.

In an embodiment, a method for producing the oil-based colorant composition disclosed herein, comprises the steps of:
a. blending an edible oil, an emulsifier and raw colorant particles comprising anthocyanin-based colorant extract from red sweet potato; said raw colorant particles having a mean particle diameter (D_{0.9}) greater than 20 μm;
b. milling the blend from step a. such that the colorant particles obtain a mean particle diameter (D_{0.9}) of less than 20 μm, thereby providing the oil-based colorant composition disclosed herein.

By the term “raw” is meant colorant particles having a mean particle diameter (D_{0.9}) greater than 20 μm. As already mentioned, the present colorant particles comprising an anthocyanin-based colorant extract from red sweet potato provides in an embodiment a stable and bright red-orange coloring composition, which is especially suited for food coloring, and especially for coloring dairy food products, fruit preparations, snack-foods and confectionery, preferably snack foods. Due to the lack of off-taste and off-flavors, e.g. off-taste and off-flavors linked to the presence of sulfur compounds, the present coloring composition in an embodiment can also be used for coloring sensitive food compositions such as dairy food products, fruit preparations, snack-foods and confectionery, preferably snack foods without negative effect on the overall flavor and taste thereof. Blending according to step a. will produce an emulsion.

In another embodiment, a method for producing the food product disclosed herein, comprises the steps of:
i. blending an edible oil, an emulsifier and raw colorant particles comprising an anthocyanin-based colorant extract from red sweet potato, the raw colorant particles being in particle form with a mean particle diameter (D_{0.9}) greater than 20 μm;
ii. milling the blend from step i. to provide the oil-based colorant composition described herein, and;
iii. formulating the oil-based composition in or on the food product.

By the term “raw” is meant colorant particles having a mean particle diameter (D_{0.9}) greater than 20 μm. In a further embodiment, the method comprises the step of adding a water-soluble food ingredient, before or after any one of steps i, ii or iii, preferably before step iii., even more preferably before step ii. Blending according to step i. will produce an emulsion.

In a further embodiment, the method the oil-based colorant composition is coated on the food product.

Provided herein is also the use of the oil-based colorant composition as disclosed herein for coloring a food, a beverage or a pharmaceutical product, suitably a fat-based food product.

Further provided herein is also the use of colorant particles as disclosed herein for coloring a food, a beverage or a pharmaceutical product, suitably a fat-based food product.

Further provided herein is also a food product comprising the herein disclosed colorant particles.

The term “water-soluble” refers to products having a solubility in water of at least 100 g/l . . .

The following items are preferred embodiments of the present invention:
Item 1. Colorant particles comprising anthocyanin-based colorant extract from red sweet potato, said colorant particles having a mean particle diameter (D_{0.9}) of less than 20 μm.
Item 2. The colorant particles according to item 1, having a mean particle diameter (D_{0.9}) of less than 15 μm, preferably less than 12 μm.
Item 3. The colorant particles according to any one of the preceding items, having a mean particle diameter (D_{0.9}) of greater than 1 μm, preferably greater than 2 μm.
Item 4. The colorant particles according to any one of the preceding items, wherein the colorant extract comprises at least one pelargonidin-based anthocyanin.
Item 5. The colorant particles according to any one of the preceding items, further comprising a carrier material.
Item 6. The colorant particles according to any one of the preceding items, wherein the red sweet potato is Ipomoea batatas.
Item 7. An oil-based colorant composition, being a suspension of (a) colorant particles according to any one of items 1-6, suspended in a mixture of (b) an edible oil and (c) an emulsifier.
Item 8. The colorant composition according to item 7, comprising the colorant particles in an amount of 10-55 weight %, 20-50 weight %, preferably in an amount of 30-50 weight %.
Item 9. The colorant composition according to any one of items 7-8, comprising the emulsifier in an amount of 0.1-5 weight %, preferably an amount of 1.5-3 weight %.
Item 10. The colorant composition according to any one of items 7-9, comprising the edible oil in an amount of less than 70 weight %, such as less than 60 weight %, preferably in an amount of 40-60 weight %, such as 50-60 weight %, more preferably 57-59 weight %.
Item 11. The colorant composition according to any one of items 7-10, wherein the edible oil is selected from the group consisting of sunflower oil, soya oil, coconut oil, canola oil, olive oil, palm oil, corn oil and mixtures thereof, preferably sunflower oil and soya oil or mixtures thereof.
Item 12. The colorant composition according to any one of items 7-11, wherein the edible oil is selected from the group consisting of sunflower oil, soya oil, coconut oil, canola oil, olive oil, palm oil, corn oil and mixtures thereof, preferably sunflower oil and soya oil or mixtures thereof, preferably sunflower oil.
Item 13. The colorant composition according to any one of items 7-12, wherein the emulsifier is a non-ionic emulsifier, preferably a fatty acid ester or fatty acid amide of a polyalcohol, more preferably a fatty acid ester of a polyalcohol.
Item 14. The colorant composition according to item 13, wherein the fatty acid ester or fatty acid amide comprises a C2-C22 fatty acid moiety, e.g. a C4-C18 fatty acid moiety or a C6-C12 fatty acid moiety.
Item 15. The colorant composition according to any one of items 13-14, wherein the fatty acid moiety is saturated.
Item 16. The colorant composition according to any one of items 13-15, wherein the polyalcohol is selected from glycerol, sorbitan, ethoxylated sorbitan, glucose, ethylene glycol, polyethylene glycol or amine derivatives thereof.
Item 17. The colorant composition according to any one of items 13-16, wherein the emulsifier is a mono- or a di-fatty acid ester of glycerol, optionally comprising an additional C1-C6 ester moiety, such as a citric acid ester moiety, preferably a citric acid ester of a mixture of mono- and diglycerides.
Item 18. The colorant composition according to any one of items 7-17, having a red color with a hue value H in the L*C*h color system in the range of 5-30, preferably 8-20, and an L*-value of 60.0-71.0.
Item 19. The colorant composition according to any one of items 7-18, further comprising an additional food colorant.
Item 20. The colorant composition according to any one of items 7-19, further comprising at least one water-soluble food ingredient(s).
Item 21. A method for producing the oil-based colorant composition according to any one of items 7-20, the method comprising the steps of:
   a. blending an edible oil, an emulsifier and raw colorant particles comprising anthocyanin-based colorant extract from red sweet potato; said raw colorant particles having a mean particle diameter (D_{0.9}) greater than 20 μm;
   b. milling the blend from step a. such that the colorant particles obtain a mean particle diameter (D_{0.9}) of less than 20 μm, thereby providing the oil-based colorant composition of any one of items 7-20.
Item 22. The method according to item 21, wherein the edible oil is as defined in any one of items 10-12, and/or wherein the emulsifier is as defined in any one of items 13-17 and/or the colorant particles are as defined in any one of items 1-6.
Item 23. A food product comprising the oil-based colorant composition according to any one of items 7-20.
Item 24. The food product according to item 23, further comprising at least one water-soluble food ingredient.
Item 25. The food product according to any one of items 23-24, being selected from the group consisting of dairy food products, fruit preparations, snack-foods and confectionery, preferably snack foods or baked goods.
Item 26. A method for producing a food product according to any one of items 23-25, said method comprising the steps of:
   i. blending an edible oil, an emulsifier and raw colorant particles comprising an anthocyanin-based colorant extract from red sweet potato, the raw colorant particles being in particle form with a mean particle diameter (D_{0.9}) greater than 20 μm;
   ii. milling the blend from step i. to provide the oil-based colorant composition of any one of items 7-20, and;
   iii. formulating the oil-based composition in or on the food product.
Item 27. The method according to item 26, further comprising the step of adding a water-soluble food ingredient, before or after any one of steps i, ii or iii, preferably before step ill., even more preferably before step ii.
Item 28. The method according to any one of items 26-27 wherein the oil-based colorant composition is coated on the food product.
Item 29. A food product comprising colorant particles according to any one of items 1-6.

Embodiments of the present invention are described below, by way of non-limiting examples.

### EXAMPLES

### Examples 1-7

Examples 1-7 were conducted to determine formula variables and processing parameters to yield optimal color expression and create a stable suspension under ambient storage conditions. Formula variables include optimizing pigment load and addition of an oil structuring ingredient. All variables were tested in sunflower oil. Other oils may be used; however, pigment load and emulsifier type may need to be optimized for each oil system. Milling parameters include bead load, mill speed, bead size, flow rate and number of passes through the mill. Optimizing formulation and processing parameters produced desired colorimetric results, particle size and stability of the blend.

All percentages are given in weight % (w/w).

In these examples, the pigment was extracted from red sweet potatoes. The sweet potatoes were selected based on the desired colorimetric and compositional characteristics. The sweet potatoes were water washed, and ground in the presence of acidified water and an enzyme. Juice was then extracted from the mash in the presence of a strong basic solution. The juice was concentrated through microfiltration or resin separation until the desired concentration was achieved. The concentrated juice was then slurried with a carrier and spray dried to a specific strength and particle size. The resulting powder had a color strength in the range of 9-12 CU/kg.

Formulation examples were conducted under standard milling parameters. Examples 1-7 were conducted on a Premier 0.20 L bench top mill. These parameters are commonly used parameters. By maintaining process parameters, the difference in color expression can be attributed to formulation. All variables were treated to a ‘fast pass’ through the mill as a coarse mixing step, then up to 2 passes with slower flow rate. Samples were collected between each pass.

### Mill Parameters

Bead Load: 70% of chamber
Bead Size and composition: 0.6-0.8 mm silica beads
Pump speed/back pressure: 12 psi
Amps output: 2.0-2.1 Amps
FPM: 1665
Mill speed: 50 Hz
Temp range: 25-36.9° C.
Active chilling at 10° C. on milling chamber

### Formulation Ingredients

Red Sweet Potato-contains Sweet Potato concentrate and glucose syrup solids. Particle size above 20 μm.
Black Carrot-contains black carrot juice concentrate, glucose syrup solids and citric acid.
Citric acid ester of mono- and diglycerides
Sunflower Oil
mono and di-glycerides

### Example 1 No Emulsifier

70% Sunflower Oil
30% Red Sweet Potato Ipomoea batatas

Process observations: Nothing abnormal noted. Temperature increased from 24° C. to 27° C. over the three passes. The suspension separated easily and appeared grainy.

### Example 2 Citric Acid Ester of Mono and Diglycerides

68.8% Sunflower Oil
30% Red Sweet Potato Ipomoea batatas
1.2% Citric acid ester of mono- and diglycerides

Process observations: The blend prior to milling appeared grainier than example 1. Temperature increased from 25° C. to 29.5° C.

### Example 3 Mono and Diglycerides

65% Sunflower Oil
30% Red Sweet Potato Ipomoea batatas
5% mono- and diglyceride

Process observations: This blend was more uniform in consistency than Example 2. Temperature increased from 25° C. to 28.5° C.

### Example 4 No Emulsifier, higher pigment load

60% Sunflower Oil
40% Red Sweet Potato Ipomoea batatas

Process observations: Temperature increased from 25° C. to 28° C. The appearance of the blend without emulsifier is grainy and separates.

### Example 5 Mono and Diglycerides, higher pigment load

58% Sunflower Oil
40% Red Sweet Potato Ipomoea batatas
2% mono- and diglyceride

Process observations: Temperature increased from 25° C. to 39.6° C. This increase in temperature is attributed to a higher viscosity of the oil suspension due to higher pigment loading and the presence of mono and di-glyceride

### Example 6 Mono and Diglycerides, higher pigment load

56% Sunflower Oil
40% Red Sweet Potato Ipomoea batatas
4% mono and diglyceride

Process observations: Temperature increased from 25° C. to 37.4° C. This increase in temperature is attributed to a higher viscosity of the oil suspension due to higher pigment loading and the presence of mono- and diglyceride

### Example 7 Citric Acid Esters of Mono and Di-Glyceride, Higher Pigment Load, Mixed Pigments

59.18 Sunflower Oil
38.0% Red Sweet Potato Ipomoea batatas
1.62% Black Carrot
1.2% Citric acid ester of mono- and diglycerides

Process observations: Temperature increased from 25° C. to 36.6° C.

The particle size D (0.9) was measured to 11.28 after third milling pass.

TABLE 1
Spectrocolorimetric results

| | | L* | C | h |
|---|---|---|---|---|
| Example 1 | Pass 2 | 70.44 | 21.23 | 17.07 |
| | Pass 3 | 70.16 | 22.37 | 16.46 |
| Example 2 | Pass 3 | 70.17 | 19.95 | 14.63 |
| Example 3 | Pass 3 | 70.02 | 19.37 | 14.67 |
| Example 4 | Pass 2 | 69.41 | 20.13 | 14.37 |
| | Pass 3 | 68.9 | 21.07 | 13.40 |
| Example 5 | Pass 3 | 69.02 | 21.53 | 13.50 |
| Example 6 | Pass 3 | 68.39 | 22.18 | 13.19 |
| Example 7 | Pass 3 | 68.69 | 21.81 | 13.02 |

Each example was milled three passes however all passes from each example was not measured. During examples it was determined that the third pass colorimetric data was the most significant.

### Conclusions from Examples 1-7

Formulation conclusions based on collected data: Citric acid ester of mono- and diglycerides is the preferred emulsifier based on examples 1-7, but any emulsifier may be used by altering pigment load, emulsifier dosage and milling parameters. The blends containing mono and di-glycerides were more viscous and generated more heat during the milling process. The addition of a second pigment to the formulation is desirable to allow for hue correction from crop year to crop year. Based on the collected data the optimum milling process requires three passes through the mill, a 70% bead load, a bead size of 0.6 mm-0.8 mm, a flow rate of 12 psi and a mill speed of 50 hertz. Different parameters can be utilized, provided a suitable particle size for adequate suspension is achieved without heat degradation.

### Examples 8-12

Examples 8-12 were conducted to optimize formula with respect to pigment load and citric acid ester of mono- and diglycerides. Milling parameters and production upscaling feasibility, which included bead load, mill speed, flow rate, and number of passes through the mill were investigated.
Mill: Ball Mill
Mill Parameters
Bead Load: 70% of chamber
Bead Size and composition: 0.6-0.8 mm ceramic beads
Pump speed/back pressure: 12 l/min
Mill speed: 12 Hz
Temp range: 23-27° C.
Active chilling at 40° C. on milling chamber

### Example 8

58.8% Sunflower oil
40.0% Red Sweet Potato Ipomoea batatas
1.2% Citric acid ester of mono- and diglycerides

Process Observations: Temp increased 23-27° C.

### Example 9

58.5% Sunflower oil
40.0% Red Sweet Potato Ipomoea batatas
1.5% Citric acid ester of mono- and diglycerides

Process Observations: Temp range 24-27° C. Stable run, no pressure spikes

### Example 10

58.0% Sunflower oil
40.0% Red Sweet Potato Ipomoea batatas
2.0% Citric acid ester of mono- and diglycerides

Process Observations: Temp range 24-27° C. Stable run, no pressure spikes. Viscosity is in range to not cause undue heat generation in the mill. The particle size D (0.9) was measured to 11.15 after second milling pass and to 9.86 after third milling pass.

### Example 11

58.5% Sunflower oil
36.76% Red Sweet Potato Ipomoea batatas
1.5% Citric acid ester of mono- and diglycerides
3.24% Black Carrot

Process Observations: Temp range 24-26° C. The example was run with no difficulties. The particle size D (0.9) was measured to 11.41 after second milling pass and to 11.62 after third milling pass.

### Example 12

57.5% Sunflower oil
40.0% Red Sweet Potato Ipomoea batatas
2.5% Citric acid ester of mono- and diglycerides

Process Observations: Temp range 24-31° C. The increased amount of emulsifier increased viscosity, and therefore the temperature. In this example.

### Spectrocolorimetric Measurements

Instrument: Minolta 3700 D Reflection 30 mm, quartz cuvette
Dilution: 0.225 g/40 g sunflower oil/60 g powdered sugar

TABLE 2
Spectrocolorimetric results

| | | L* | C | h |
|---|---|---|---|---|
| Example 8 | Pass 1 | 67.84 | 23.69 | 15.37 |
| | Pass 2 | 67.15 | 26.07 | 14.45 |
| | Pass 3 | 66.94 | 27.12 | 13.77 |
| Example 9 | Pass 1 | 67.88 | 24.7 | 14.1 |
| | Pass 2 | 67.08 | 26.67 | 13.16 |
| | Pass 3 | 66.99 | 27.28 | 13.25 |
| Example 10 | Pass 1 | 67.57 | 24.52 | 14.96 |
| | Pass 2 | 66.69 | 27.07 | 13.77 |
| | Pass 3 | 67.26 | 27.06 | 13.06 |
| Example 11 | Pass 1 | 67.75 | 24.42 | 13.38 |
| | Pass 2 | 65.81 | 26.27 | 12.44 |
| | Pass 3 | 65.77 | 26.75 | 12.08 |

each example was milled three passes however all passes from each example was not measured. During examples it was determined that the third pass colorimetric data was the most significant.

Lightness decreased with each pass through the mill, while chroma, indicating a higher saturation of color, increased over each subsequent pass through the mill.

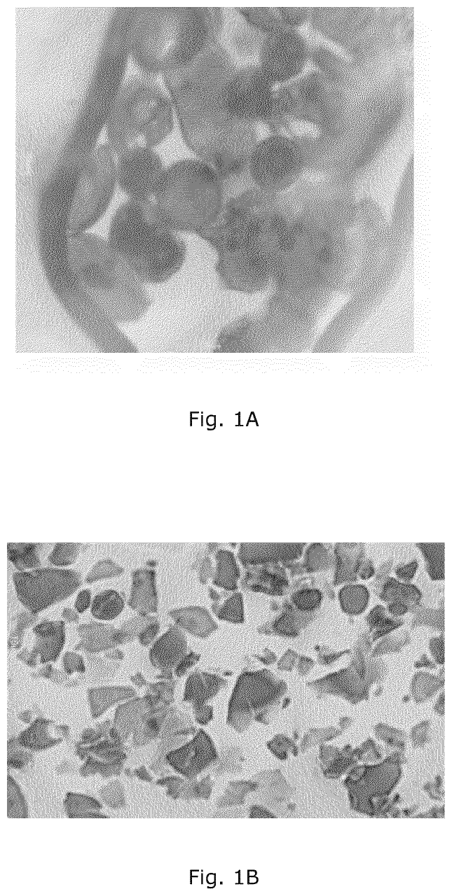

FIGS. 1A and 1B show images of a blend from Example 8 viewed under an optical microscope. FIG. 1A is pre-milling; FIG. 1B is one milled pass.

Five examples using red sweet potato extract were run through the mill without difficulty. It was determined This has provided some viscosity to the final product that will help suspension of the pigment. Application testing was conducted in seasoned oil slurry. The citric acid ester of mono- and diglycerides at 2.5% in the formulation could be detected when the snacks were tasted. The formula and processing used in example 4 were preferred.

### Example 13

This example was conducted to verify formulation and milling parameters. Bulk stability is also monitored from this example.
Mill: Ball Mill
Mill Parameters
Bead Load: 70% of chamber
Bead Size and composition: 0.6-0.8 mm ceramic beads
Pump speed/back pressure: 12 l/min
Mill speed: 12 Hz
Temp range: 23-27° C.
Active chilling at 4° C. on milling chamber
Amps 3.8-4.0

### Formulation

58.5% Sunflower oil
36.76% Red Sweet Potato Ipomoea batatas
1.5% Citric acid ester of mono- and diglycerides
3.24% Black Carrot (for shade adjustment)

### Spectrocolorimetric Measurement

Instrument: Minolta 3700 D Reflection 30 mm, quartz cuvette
Dilution: 0.225 g/40 g sunflower oil/60 g powdered sugar

TABLE 3
Spectrocolorimetric results

| Reading | L* | C | h |
|---|---|---|---|
| Example 13; 1^{st} pass | 66.54 | 22.73 | 9.68 |
| Example 13; 2nd pass | 65.60 | 24.34 | 8.09 |
| Example 13; 3rd pass | 65.08 | 25.31 | 7.75 |

Color became brighter and more intense with increasing passes.

### Particle Size Analysis

The light-scattering measurements of oil soluble products were carried out using a Malvern Hydro SM cell (Malvern Instrument). The software used was Mastersizer 2000. The method calculated d (0.9). The system uses the Frauenhofer; simple mathematical calculation-system. Which assumes media is a perfect round particle/droplet (opal particle). The samples are distributed in mct oil.

d(x)=y μm means that x % of the powder has a diameter<y μm.

TABLE 4
Particle size analysis

| Sample ID | d(0.9) |
|---|---|
| Example 13; 1^{st} pass | 15.491 |
| Example 13; 2nd pass | 11.243 |
| Example 13; 3rd pass | 10.055 |

The first pass was a quick pass through the mill to make the mix more homogeneous before the slower 2nd and 3rd pass to refine particle size. D (0.90) of <20 micrometer has been determined experimentally to be important for smooth texture, suspension of the pigments and color expression.

In summary, suspension of the color was attained with a combination of particle size of the water-soluble pigment and the use of an oil structuring emulsifier. The ingredients and parameters to achieve these results vary by pigment and emulsifier. Milling parameters can be altered to achieve the right particle size and viscosity in the finished product.

### Utilization of Red Sweet Potato

The red sweet potato utilized in this study shifts color less than a standard black carrot anthocyanin. Color measurements were taken in whole milk at same pigment content.

Method: Each sample was added to whole milk at a specified dosage rates (Red sweet potato powder at 0.1125%, and Black carrot at 0.1%) as to maintain comparable pigment strength. The samples were adjusted to pH's of 4, 5, 6, and 7 using citric acid and trisodium citrate. Once the desired pH was obtained, each sample was measured on the DataColor spectrophotometer for L, Chroma, and Hue values,

TABLE 5
Color shift study

| | pH | L* | C | h | delta E |
|---|---|---|---|---|---|
| Black Carrot | 4 | 77.68 | 14.76 | 358.03 | 0 |
| | 5 | 77.55 | 10.46 | 345.17 | 4.11 |
| | 6 | 75.59 | 8.21 | 329.47 | 7.43 |
| | 7 | 73.69 | 6.19 | 300.12 | 12.21 |
| Sweet Potato | 4 | 80.41 | 16.85 | 2.48 | 0 |
| | 5 | 80.89 | 14.3 | 353.6 | 2.5 |
| | 6 | 77.71 | 15.85 | 345.76 | 3.85 |
| | 7 | 76.27 | 14.32 | 335.93 | 6.15 |

With both pigments, a clear shift from red to more blue was observed, with black carrot shifting bluer than the sweet potato. Delta E is a common way to depict change in color from a reference. A delta E of less than 2 is typically understood to be no different to the untrained eye.

### Example 14

Mill: Ball Mill
Mill Parameters
Bead Load: 70% of chamber
Bead Size and composition: 0.6-0.8 mm ceramic beads
Pump speed/back pressure: 12 l/min
Mill speed: 12 Hz
Temp range: 22-43° C.
Active chilling at 4° C. on milling chamber
Amps 3.8-4.0

### Formulation

48% Sunflower Oil
50% Red Sweet Potato Ipomoea batatas
2% Citric acid ester of mono- and diglycerides

Process observations: Temperature ranged from 22.4° C. to 22.9° C. The temperature was fairly consistent.

TABLE 6
Spectrocolorimetric and particle size results

| | L* | C | h | d(0.9) |
|---|---|---|---|---|
| Pass 2 | 69.02 | 24.59 | 8.37 | 10.54 |
| Pass 3 | 68.28 | 25.47 | 8.12 | 12.00 |

### Example 15

### Formulation

57.0% Sunflower Oil
40.0% Red Sweet Potato Ipomoea batatas
3.0% Citric acid ester of mono- and diglycerides

Process observations: Temperature increased from 35° C. to 42° C. Increased viscosity.

TABLE 7
Spectrocolorimetric and particle size results

| | L* | C | h | d(0.9) |
|---|---|---|---|---|
| Pass 2 | 76.10 | 27.30 | 11.50 | 6.45 |
| Pass 3 | 77.20 | 27.10 | 11.10 | 5.01 |

The present invention has been described with reference to a number of examples, aspects and embodiments. However, the skilled person may combine features from various examples, aspects and embodiments while remaining within the scope of the appended claims.

1-16. (canceled)

17. A method of using an oil-based colorant composition, the composition being a suspension of
(a) anthocyanin-based extract from a red sweet potato having a particle diameter (D_{0.9}) of less than 20 μm, suspended in a mixture of
(b) an edible oil and (c) an emulsifier for coloring fat-based food products, wherein the emulsifier is a non-ionic emulsifier, and
(c) formulating the oil-based composition in or on the food product.
